(19) United States
(12) Patent Application Publication
(10) Pub. No.: US 2026/0312127 A1
(43) Pub. Date: Oct. 8, 2026

(54) SULPHIDE BASED LITHIUM-ION MIXED HALIDE CONDUCTING SOLID ELECTROLYTE AND METHODS FOR THE PRODUCTION THEREOF

(71) Applicant: Umicore, Brussels (BE)

(72) Inventors: Antoine BREHAULT, Acigné (FR); Pol BRIANTAIS, Acigné (FR); Yann GUIMOND, Acigné (FR); Stef KERKHOFS, Olen (BE)

(21) Appl. No.: 19/479,774

(22) PCT Filed: Apr. 29, 2024
(86) PCT No.: PCT/EP2024/061743

§ 371 Date: Oct. 29, 2025

(30) Foreign Application Priority Data
May 3, 2023 (EP) 23290013.4

(51) Int. Cl. H01M 10/0562; H01M 10/0525; H01M 50/431

(52) U.S. Cl. CPC H01M 10/0562; H01M 10/0525; H01M 50/431; H01M 2300/008

(57) ABSTRACT

The present invention relates to solid materials which are obtainable by melt-quenching mixtures of lithium sulphide, boron sulphide, boron oxide and lithium halides, thereby forming a glassy solid which is suitable for use as a lithium-ion conducting electrolyte. These sulphide based lithium-ion conducting solid electrolytes exhibit a high ionic conductivity.

### TECHNICAL FIELD AND BACKGROUND

The present invention relates to solid materials which are obtainable by melt-quenching mixtures of lithium sulphide, boron sulphide and boron oxide, thereby forming a glassy solid which is suitable for use as a lithium-ion conducting electrolyte. The present invention further relates to methods to prepare said solid materials, to electrochemical cells such as solid-state batteries comprising said solid materials and to uses of the solid material in electrochemical cells such as solid-state batteries, in particular as an electrolyte.

The three primary functional components of a lithium-ion battery are the anode, the cathode, and the electrolyte. While many variations exist, the anode of a conventional lithium-ion cell is typically made from carbon, the cathode is typically made from transition metal oxides (in particular oxides of cobalt, nickel and/or manganese), and the electrolyte is typically a non-aqueous solvent containing a lithium salt. For example, mixtures of organic carbonates with lithium hexafluorophosphate are well known liquid electrolytes for lithium-ion batteries.

A significant disadvantage of liquid electrolytes is that the compositions, in particular the solvents are inflammable, which poses a large safety risk during normal operation and in particular in case of an incident. Another disadvantage is inherent to the liquid nature of the electrolyte, associated with risks of leakage and with increased risk of environmental pollution in case of a spill or leakage.

Recently, efforts have been made to develop solid electrolytes which allow the provision of a solid-state lithium-ion battery. Such solid-state batteries have significantly reduced EHS (environmental, health and safety) hazards. An emerging class of lithium-ion conducting solid electrolytes are sulphide based amorphous solids (interchangeably referred to as glassy solids) such as Li₂S—SiS₂, Li₂S—P₂S₅ or Li₂S—B₂S₃. In glassy solid electrolyte materials, the absence of crystalline pathways leads to isotropic conduction substantially without any grain boundary resistance. The absence of grain boundaries in glassy electrolyte materials may also prevent dendrite formation because glassy amorphous electrolyte materials may be obtained as dense, defect free films by a melt-quench approach.

Early studies on Li₂S—B₂S₃ compositions having a molar ratio of 70:30 and 60:40 reported ionic conductivity values of 0.095 and 0.016 mS/cm, respectively (Zhang et al, Solid State Ionics 1990, 38, 217-224).

U.S. Pat. No. 5,500,291 contemplates sulphide based lithium-ion conducting solid electrolytes of the type Li₂S—SiS₂—Li₄SiO₄.

WO2020/254314 A1 contemplates sulphide based lithium-ion conducting solid electrolytes of the type Li₂S—B₂S₃ obtained from mixtures further comprising P, Si, Ge, As or Sb oxides in combination with lithium halides. The resulting glassy solids are said to have favourable lithium-ion conductivity as well as electrochemical stability in direct contact with lithium metal and chemical stability against air and moisture.

WO2016/089899 A1 contemplates a plethora of glass systems (many of which are speculative or unsupported). Paragraphs 188 and 189 of WO2016/089899 A1 describes several Li₂O—B₂S₃—SiS₂ based systems.

A drawback related to most sulphide based lithium-ion conducting solid electrolytes known in the art is that they have a low ionic conductivity. Presently, there is therefore a significant need to provide sulphide based lithium-ion conducting solid electrolytes combining both properties.

It is an object of the present invention to provide sulphide based lithium-ion conducting solid electrolytes having a high ionic conductivity. It is another object of the present invention to provide sulphide based lithium-ion conducting solid electrolytes having a low electric conductivity.

### SUMMARY OF THE INVENTION

The present inventors have found that one or more objects of the invention can be achieved by providing sulphide based lithium-ion conducting solid electrolytes obtainable by melt-quenching a combination of Li₂S; B₂S₃; B₂O₃; LiI and LiX in well-defined ratios, wherein X represents Cl, Br or combinations thereof. As is shown in the appended examples, it is indeed observed that the resulting glassy solids exhibit high ionic conductivities and/or low electric conductivities.

Accordingly, in a first aspect of the present invention, there is provided a solid material having a composition according to general formula (I)

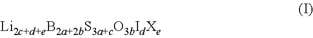

wherein
X represents Br or Cl, or combinations thereof;
a is within the range of 0.015 to 0.15;
b is within the range of 0 to 0.04;
c is within the range of 0.07 to 0.25;
d is within the range of 0.001 to 0.24; and
e is within the range of 0.001 to 0.24.

In another aspect of the present invention, there is provided a solid material which is obtainable by melt-quenching a mixture of A, B and C, wherein the molar ratio of A, B and C in the mixture before quenching is within the range of 40:30:30 to 98:1:1.

wherein component A is according to general formula (II)

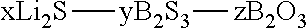

wherein
x is within the range of 55 to 85;
y is within the range of 15 to 45;
z is within the range of 0 to 15;
x+y+z=100; and
wherein component B is LiI;
wherein component C is LiX, wherein X represents Br, Cl or combinations thereof.

In another aspect of the present invention, there is provided a method for preparing a solid material comprising the steps of:
(i) providing the following precursors:
   Li₂S;
   B₂S₃ and/or both of boron and sulfur;
   optionally B₂O₃;
   LiI; and
   LiX wherein X represents Cl, Br or combinations thereof;
(ii) preparing a mixture comprising the precursors provided in step (i) wherein
   in said mixture the molar ratio of the elements Li, S, B, O, I and X matches the general formula (I) as defined herein;
or
   in said mixture the molar ratio of the precursors matches the general formula (II) as defined herein;
(iii) heat-treating the mixture prepared in step (ii) to obtain a melt; and
(iv) quenching the melt obtained in step (iii) to obtain the solid material.

In another aspect of the invention, there is provided a solid composition comprising a first solid material which is the solid material as described herein, and further comprising at least a second solid material having a different composition than the first solid material.

In another aspect of the invention, there is provided an electrochemical cell comprising the solid material as described herein.

In another aspect of the invention, there is provided the use of the solid material as described herein, or of the solid composition as described herein, as a solid electrolyte for an electrochemical cell.

Another aspect of the present invention concerns batteries, more specifically a lithium ion battery or a lithium metal battery comprising at least one electrochemical cell comprising the solid material as described herein, for example two or more electrochemical cells as described herein.

A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one battery or at least one electrochemical cell comprising the solid material as described herein (i.e. the electrochemical cell as described herein).

A further aspect of the present disclosure is the use of the electrochemical cell comprising the solid material of the invention (i.e. the electrochemical cell as described herein) in motor vehicles, bicycles operated by electric motor, robots, aircraft (for example unmanned aerial vehicles including drones), ships or stationary energy stores.

In another aspect of the invention, there is provided the use of a combination of LiI and lithium salt of formula LiX wherein X represents Cl, Br or combinations thereof, for improving the ionic conductivity of a glassy solid, in particular for improving the ionic conductivity of a sulphide based lithium ion conducting solid electrolyte.

### DETAILED DESCRIPTION OF THE INVENTION

In the following detailed description, preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description

The ionic conductivity as referred to herein, refers to the ionic conductivity determined by electrochemical impedance spectroscopy (EIS) at 25° C. It is preferably determined with ion-blocking electrodes on hot pressed samples which were densified at 350 MPa at 125° C. for 5 min after which the ionic conductivity was measured at 25° C. under an operational pressure of 125 MPa. Preferably an excitation voltage of 10 mV was applied in the frequency range of 7 MHz-1 Hz and the data was interpreted by means of an equivalent circuit analysis. A suitable conductivity analyzer is a potentiostat with frequency analyzer such as is available from Biologic.

The electronic conductivity as referred to herein, refers to the electronic conductivity determined at 25° C. It is preferably determined with ion-blocking electrodes on hot pressed samples which were densified at 350 MPa at 125° C. for 5 min after which the electronic conductivity was measured at 25° C. under an operational pressure of 125 MPa. Preferably the electronic conductivity was measured via stepwise potentiostatic polarization at 0.2, 0.4 and 0.6 V for 20 min. A suitable conductivity analyzer is a potentiostat with frequency analyzer such as is available from Biologic.

The molar ratios as referred to herein, for example the molar ratios of components A, B and C mean that the ratio of A, B and C is defined in the following unit mol/mol/mol.

In a first aspect of the present invention, there is provided a solid material having a composition according to general formula (I)

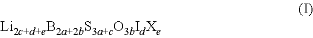

wherein
X represents Br or Cl, or combinations thereof;
a is within the range of 0.015 to 0.15;
b is within the range of 0 to 0.04;
c is within the range of 0.07 to 0.25;
d is within the range of 0.001 to 0.24; and
e is within the range of 0.001 to 0.24.

Without wishing to be bound by any theory, the present inventors believe that the solid materials according to formula (I) are the result obtained when melt quenching a mixture Li₂S; B₂S₃; B₂O₃; LiI and LiX in well-defined ratios, wherein X represents Cl, Br or combinations thereof as is explained herein in the context of other aspects of the invention, and in the examples.

The solid material having a composition according to general formula (I) is preferably provided wherein
a is within the range of 0.02 to 0.09;
b is within the range of 0 to 0.03;
c is within the range of 0.09 to 0.20;
d is within the range of 0.001 to 0.21; and
e is within the range of 0.001 to 0.21;
   more preferably wherein
a is within the range of 0.03 to 0.085;
b is within the range of 0.007 to 0.02;
c is within the range of 0.10 to 0.20;
d is within the range of 0.001 to 0.15; and
e is within the range of 0.001 to 0.15;
In general, it is preferred that d and e are within the range 0.005 to 0.15, preferably within the range of 0.009 to 0.10, more preferably within the range 0.01 to 0.07. In some embodiments, d and e are within the range of 0.001 to 0.15, preferably within the range of 0.005 to 0.15, more preferably within the range of 0.01 to 0.15. In some embodiments, d and e are within the range of 0.005 to 0.10, preferably within the range of 0.009 to 0.08, more preferably within the range of 0.01 to 0.07.

Hence, in some embodiments of the invention the solid material having a composition according to general formula (I) is provided wherein a is within the range of 0.03 to 0.085;
b is within the range of 0 to 0.03;
c is within the range of 0.10 to 0.20;
d is within the range of 0.001 to 0.15, preferably within the range of 0.005 to 0.10, more preferably within the range of 0.01 to 0.07; and
e is within the range of 0.001 to 0.15, preferably within the range of 0.005 to 0.10, more preferably within the range of 0.01 to 0.07;
   more preferably wherein
a is within the range of 0.04 to 0.085;
b is within the range of 0.007 to 0.025;
c is within the range of 0.10 to 0.18;
d is within the range of 0.001 to 0.15, preferably within the range of 0.005 to 0.10, more preferably within the range of 0.01 to 0.07; and
e is within the range of 0.001 to 0.15, preferably within the range of 0.005 to 0.10, more preferably within the range of 0.01 to 0.07.

Hence, in some embodiments of the invention the solid material having a composition according to general formula (I) is provided wherein
a is within the range of 0.050 to 0.080;
b is within the range of 0.009 to 0.020;
c is within the range of 0.11 to 0.18;
d is within the range of 0.005 to 0.15; and
e is within the range of 0.005 to 0.15.

In accordance with highly preferred embodiments of the invention, the solid material having a composition according to general formula (I) is provided wherein
a is within the range of 0.053 to 0.066, preferably within the range of 0.056 to 0.063, more preferably within the range of 0.058 to 0.061, most preferably a is about 0.060;
b is within the range of 0.009 to 0.011 preferably within the range of 0.0095 to 0.010, more preferably b is about 0.010;
c is within the range of 0.11 to 0.14 preferably within the range of 0.0125 to 0.135, more preferably c is about 0.0130;
d is within the range of 0.045 to 0.09, preferably within the range of 0.055 to 0.075, more preferably within the range of 0.060 to 0.070, most preferably d is about 0.066; and
e is within the range of 0.045 to 0.09, preferably within the range of 0.055 to 0.075, more preferably within the range of 0.060 to 0.070, most preferably e is about 0.066.

In accordance with highly preferred embodiments of the invention, the solid material having a composition according to general formula (I) is provided wherein
a is within the range of 0.055 to 0.075, preferably within the range of 0.06 to 0.07, more preferably a is about 0.066;
b is within the range of 0.0085 to 0.015 preferably within the range of 0.009 to 0.01, more preferably b is about 0.011;
c is within the range of 0.0135 to 0.0155 preferably within the range of 0.014 to 0.015, more preferably c is about 0.0143;
d is within the range of 0.035 to 0.055, preferably within the range of 0.04 to 0.05, more preferably d is about 0.047; and
e is within the range of 0.035 to 0.055, preferably within the range of 0.04 to 0.05, more preferably e is about 0.047.

In accordance with highly preferred embodiments of the invention, the solid material having a composition according to general formula (I) is provided wherein
a is within the range of 0.065 to 0.080, preferably within the range of 0.069 to 0.075, more preferably within the range of 0.070 to 0.072, most preferably a is about 0.071;
b is within the range of 0.010 to 0.015 preferably within the range of 0.011 to 0.013, more preferably b is about 0.012;
c is within the range of 0.13 to 0.17 preferably within the range of 0.15 to 0.16, more preferably c is 0.155;
d is within the range of 0.025 to 0.045, preferably within the range of 0.027 to 0.040, more preferably within the range of 0.029 to 0.035, most preferably d is about 0.030; and
e is within the range of 0.025 to 0.045, preferably within the range of 0.027 to 0.040, more preferably within the range of 0.029 to 0.035, most preferably e is about 0.030.

In accordance with highly preferred embodiments of the invention, the solid material having a composition according to general formula (I) is provided wherein
a is within the range of 0.070 to 0.080, preferably within the range of 0.072 to 0.079, more preferably within the range of 0.074 to 0.077, most preferably a is about 0.076;
b is within the range of 0.010 to 0.015 preferably within the range of 0.012 to 0.014, more preferably b is about 0.013;
c is within the range of 0.15 to 0.18 preferably within the range of 0.16 to 0.17, more preferably c is about 0.166;
d is within the range of 0.005 to 0.025, preferably within the range of 0.008 to 0.020, more preferably within the range of 0.010 to 0.017, most preferably d is about 0.014; and
e is within the range of 0.005 to 0.025, preferably within the range of 0.008 to 0.020, more preferably within the range of 0.010 to 0.017, most preferably e is about 0.014.

In each of the embodiments of the composition according to general formula (I) described herein, the molar ratios have been calculated such that the total of 5a+5b+3c+2d+2e is within the range of 0.9-1.1, preferably within the range of 0.99-1.01, most preferably about 1.

As appreciated by the skilled person, the solid material having a composition according to general formula (I), if prepared by e.g. melt-quenching, may be accompanied by minor amounts of impurity phases which typically mainly consist of the precursors used for preparing the solid material, or intermediates formed from said precursors.

In a second aspect of the present invention, there is provided a solid material which is obtainable by melt-quenching a mixture of A, B and C,
wherein the molar ratio of A, B and C in the mixture before quenching is within the range of 40:30:30 to 98:1:1;
wherein component A is according to general formula (II)

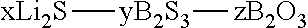

wherein
x is within the range of 55 to 85, preferably within the range of 55 to 75, more preferably within the range of 60 to 70;
y is within the range of 15 to 45, preferably within the range of 20 to 40, more preferably within the range of 25 to 35;
z is within the range of 0 to 15, preferably within the range of 0 to 10, more preferably within the range of 0 to 6;
x+y+z=100;
wherein component B is LiI; and
wherein component C is LiX, wherein X represents Br, Cl or combinations thereof.

In preferred embodiments of the invention, said solid material which is obtainable by melt-quenching a mixture of A, B and C is provided wherein
x is within the range of 62 to 68, preferably within the range of 63 to 67, more preferably within the range of 64 to 66;
y is within the range of 27 to 33, preferably within the range of 28 to 32, more preferably within the range of 29 to 31;
z is within the range of 1 to 8, preferably within the range of 3 to 7, more preferably within the range of 4 to 6; and
x+y+z=100.

In accordance with highly preferred embodiments of the invention, the solid material which is obtainable by melt-quenching a mixture of A, B and C is provided wherein
x is about 65;
y is about 30; and
z is about 5.

In general, it is preferred that the molar ratio of A, B and C in the mixture before quenching is within the range of 50:25:25 to 98:1:1, preferably 56:22:22 to 90:5:5, more preferably 64:18:18 to 80:10:10. In some embodiments the molar ratio of A, B and C in the mixture before quenching is within the range of 60:20:20 to 95:3:2, preferably within the range of 76:12:12 to 90:5:5, more preferably within the range of 70:15:15 to 82:9:9. In some highly preferred embodiments the molar ratio of A, B and C in the mixture before quenching is within the range of 50:25:25 to 96:2:2, preferably within the range of 60:20:20 to 90:5:5, more preferably within the range of 70:15:15 to 80:10:10.

In preferred embodiments the molar ratio of A, B and C in the mixture before quenching is within the range of 50:25:25 to 70:15:15, preferably 56:22:22 to 64:18:18, more preferably 58:21:21 to 62:19:19 to, most preferably about 60:20:20. In some embodiments the molar ratio of A, B and C in the mixture before quenching is within the range of 64:18:18 to 76:12:12 preferably 66:17:17 to 74:13:13, more preferably 68:16:16 to 72:14:14, most preferably about 70:15:15. In some embodiments the molar ratio of A, B and C in the mixture before quenching is within the range of 75:15:15 to 88:6:6, preferably 76:12:12 to 84:8:8, more preferably 78:11:11 to 82:9:9, most preferably about 80:10:10. In some embodiments. In some embodiments the molar ratio of A, B and C in the mixture before quenching is within the range of 84:8:8 to 98:1:1, preferably 86:7:7 to 94:3:3, more preferably 88:6:6 to 92:4:4, most preferably about 90:5:5.

Hence, in some embodiments of the invention the solid material which is obtainable by melt-quenching a mixture of A, B and C is provided wherein
x is within the range of 62 to 68, preferably within the range of 63 to 67, more preferably within the range of 64 to 66;
y is within the range of 27 to 33, preferably within the range of 28 to 32, more preferably within the range of 29 to 31;
z is within the range of 1 to 8, preferably within the range of 3 to 7, more preferably within the range of 4 to 6;
x+y+z=100; and
the molar ratio of A, B and C in the mixture before quenching is within the range of 50:25:25 to 96:2:2, preferably within the range of 60:20:20 to 90:5:5, more preferably within the range of 70:15:15 to 80:10:10.

In some embodiments of the invention the solid material which is obtainable by melt-quenching a mixture of A, B and C is provided wherein
x is about 65;
y is about 30;
z is about 5;
x+y+z=100; and
the molar ratio of A, B and C in the mixture before quenching is within the range of 50:25:25 to 70:15:15, preferably 56:22:22 to 64:18:18, more preferably 58:21:21 to 62:19:19 to, most preferably about 60:20:20.

In some embodiments of the invention the solid material which is obtainable by melt-quenching a mixture of A, B and C is provided wherein
x is about 65;
y is about 30;
z is about 5;
x+y+z=100; and
the molar ratio of A, B and C in the mixture before quenching is within the range of 64:18:18 to 76:12:12 preferably 66:17:17 to 74:13:13, more preferably 68:16:16 to 72:14:14, most preferably about 70:15:15.

In some embodiments of the invention the solid material which is obtainable by melt-quenching a mixture of A, B and C is provided wherein
x is about 65;
y is about 30;
z is about 5;
x+y+z=100; and
the molar ratio of A, B and C in the mixture before quenching is within the range of 75:15:15 to 88:6:6, preferably 76:12:12 to 84:8:8, more preferably 78:11:11 to 82:9:9, most preferably about 80:10:10.

In some embodiments of the invention the solid material which is obtainable by melt-quenching a mixture of A, B and C is provided wherein
x is about 65;
y is about 30;
z is about 5;
x+y+z=100; and
the molar ratio of A, B and C in the mixture before quenching is within the range of 84:8:8 to 98:1:1, preferably 86:7:7 to 94:3:3, more preferably 88:6:6 to 92:4:4, most preferably about 90:5:5.

In some preferred embodiments of the invention, the solid material which is obtainable by melt-quenching a mixture of A, B and C as described herein is the solid material having a composition according to general formula (I) as described herein (i.e. the solid material of the first aspect of the invention).

The solid material according to the different aspects of the invention described herein, namely the solid material having a composition according to general formula (I) as described herein (i.e. the solid material of the first aspect of the invention) and the solid material which is obtainable by melt-quenching a mixture of A, B and C as described herein (i.e. the solid material of the second aspect of the invention), are collectively referred to as “the solid material” (i.e. the solid material of the first or second aspect of the invention).

In accordance with preferred embodiments of the invention, the solid material is provided wherein X represents Br, Cl or a combination thereof.

The solid materials of the present invention are typically glassy solids, obtainable by melt-quenching a mixture of precursors as explained herein elsewhere. In some embodiments, the solid material is in the form of a monolithic glass, such as a melt-case monolithic glass. It is preferred that the glassy solid is essentially free of crystalline phases. This may mean that in some embodiments the amount of crystalline phases as determined by X-ray diffraction is less than 5 vol % of the solid material, preferably less than 2 vol %, more preferably less than 1 vol %. A phase is considered crystalline if the intensity of its reflection if more than 10% above the background.

In accordance with preferred embodiments of the invention, the solid material is provided wherein X represents Br, Cl or a combination thereof and wherein at least 50 mol % of X represents Br, preferably at least 80 mol % of X represents Br.

It was found that the solid materials of the present invention have a surprisingly high ionic conductivity. In accordance with preferred embodiments of the invention, the solid material is provided wherein the material has an ionic conductivity at 25° C. of at least 0.1 mS/cm, preferably at least 0.2 mS/cm. As is shown in the appended examples the present inventors have surprisingly found that in case at least 50 mol % of X represents Br, preferably at least 80 mol % of X represents Br, most preferably X represents Br, the ionic conductivity at 25° C. can be as high as 0.93 mS/cm. Hence, in some embodiments of the invention, the solid material is provided wherein the material has an ionic conductivity at 25° C. of at least 0.3 mS/cm, preferably at least 0.40 mS/cm, more preferably at least 0.54 mS/cm. In particular embodiments of the invention, wherein the solid materials of the present invention have:
at least 50 mol % of X represents Br, preferably at least 80 mol % of X represents Br, most preferably X represents Br; and
an ionic conductivity at 25° C. of at least 0.40 mS/cm, preferably at least 0.50 mS/cm, more preferably at least 0.54 mS/cm.

For example in some embodiments of the solid material of the invention at least 80 mol % of X represents Br and the ionic conductivity at 25° C. of the solid material is at least 0.3 mS/cm, or X represents Br and the ionic conductivity at 25° C. of the solid material is at least 0.54 mS/cm, such as at least 0.60 mS/cm or at least 0.75 mS/cm.

In accordance with preferred embodiments of the invention, the solid material is provided wherein X represents Br, Cl or a combination thereof and wherein at least 50 mol % of X represents Cl, preferably at least 80 mol % of X represents Cl.

As is shown in the appended examples the present inventors have surprisingly found that in case at least 50 mol % of X represents Cl, preferably at least 80 mol % of X represents Cl, most preferably X represents Cl, the ionic conductivity at 25° C. can be as high as 0.71 mS/cm. Hence, in some embodiments of the invention, the solid material is provided wherein the material has an ionic conductivity at 25° C. of at least 0.40 mS/cm, preferably at least 0.50 mS/cm, more preferably at least 0.62 mS/cm In particular embodiments of the invention, wherein the solid materials of the present invention have:
at least 50 mol % of X represents Cl, preferably at least 80 mol % of X represents Cl, most preferably X represents Cl; and
an ionic conductivity at 25° C. of at least 0.40 mS/cm, preferably at least 0.50 mS/cm, more preferably at least 0.62 mS/cm.

For example in some embodiments of the solid material of the invention at least 80 mol % of X represents Cl and the ionic conductivity at 25° C. of the solid material is at least 0.3 mS/cm, or X represents Cl and the ionic conductivity at 25° C. of the solid material is at least 0.62 mS/cm, such as at least 0.65 mS/cm or at least 0.70 mS/cm.

It was found that the solid materials of the present invention combine said high ionic conductivity with surprisingly low electronic conductivity, which makes them extremely attractive solid state battery electrolyte materials. In accordance with preferred embodiments of the invention, the solid material is provided wherein the material has an electronic conductivity at 25° C. of less than 1×10⁻⁴ mS/cm, preferably less than 1×10⁻⁵ mS/cm. As is shown in the appended examples the present inventors have surprisingly found that in case X represents Br, Cl or a combination thereof, the electronic conductivity at 25° C. can be very low, such as less than 1×10⁻⁵ mS/cm or less than 8×10⁻⁶ mS/cm. In particular embodiments of the invention:
X represents Br, Cl or a combination thereof; and
the solid material has an electronic conductivity at 25° C. of less than 1.0×10⁻⁶ mS/cm or less than 1.0×10⁻⁵ mS/cm.

In some particularly preferred embodiments of the invention, materials are provided combining a high ionic conductivity with a low electronic conductivity. As is shown in the appended examples, this is possible when X represents Br. For example, in some embodiments of the solid material of the invention:
at least 50 mol % of X represents Br, preferably at least 80 mol % of X represents Br, most preferably X represents Br;
the solid material has an ionic conductivity at 25° C. of at least 0.30 mS/cm, preferably at least 0.40 mS/cm, more preferably at least 0.54 mS/cm; and
the solid material has an electronic conductivity at 25° C. of less than 5.0×10⁻⁴ mS/cm or less than 1×10⁻⁵ mS/cm.

For example, in some embodiments at least 50 mol % of X represents Br, preferably at least 80 mol % of X represents Br, most preferably X represents Br; the solid material has an ionic conductivity at 25° C. of at least 0.54 mS/cm and the solid material has an electronic conductivity at 25° C. of less than 5×10⁻⁴ mS/cm.

In some particularly preferred embodiments of the invention, materials are provided combining a high ionic conductivity with a low electronic conductivity. As is shown in the appended examples, this is possible when X represents Cl. For example, in some embodiments of the solid material of the invention:
at least 50 mol % of X represents Cl, preferably at least 80 mol % of X represents Cl, most preferably X represents Cl;
the solid material has an ionic conductivity at 25° C. of at least 0.40 mS/cm, preferably at least 0.50 mS/cm, more preferably at least 0.62 mS/cm; and
the solid material has an electronic conductivity at 25° C. of less than 5×10⁻⁵ mS/cm or less than 1×10⁻⁵ mS/cm.

For example, in some embodiments at least 50 mol % of X represents Cl, preferably at least 80 mol % of X represents Cl, most preferably X represents Cl; the solid material has an ionic conductivity at 25° C. of at least 0.62 mS/cm and the solid material has an electronic conductivity at 25° C. of less than 1×10⁻⁵ mS/cm.

As is explained throughout the present application, the solid materials of the invention are obtainable by melt-quenching a mixture of precursors to obtain a glassy solid. For some applications it may be preferable that the material is provided in the form of a particulate solid, such as a powder. This may facilitate blending with e.g. cathode material. The solid may be obtained directly in the form of a particulate solid (such as a powder) or may be comminuted (such as by milling, grinding, etc.) to a particulate solid (such as a powder). For other applications it may be preferable that the solid material is provided in the form of a thin sheet or film, preferably a sheet or film having a thickness of less than 500 micron, preferably less than 100 micron.

The present inventors contemplate that the addition of small amounts of other materials during synthesis in such a way that the general formula (I) of the resulting solid material is no longer respected or in such a way that the general formula (II) is no longer respected; but wherein the changes do not materially affect the basic and novel characteristic(s) of the solid materials of the invention is possible. Such modifications are considered within the scope of the general formula (I) or (II) for the purposes of the present invention.

In a third aspect of the present invention, there is provided a method for preparing a solid material comprising the steps of:
(i) providing the following precursors:
   Li₂S;
   B₂S₃ and/or both of boron and sulfur;
   optionally B₂O₃;
   LiI; and
   LiX wherein X represents Cl, Br or combinations thereof;
(ii) preparing a mixture comprising the precursors provided in step (i) wherein
   in said mixture the molar ratio of the elements Li, S, B, O, I and X matches the general formula (I);

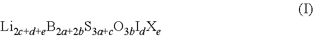

wherein
X represents Br or Cl, or combinations thereof;
a is within the range of 0.015 to 0.15;
b is within the range of 0 to 0.04;
c is within the range of 0.07 to 0.25;
d is within the range of 0.001 to 0.24; and
e is within the range of 0.001 to 0.24;
in said mixture the molar ratio of the precursors matches the general formula (II)

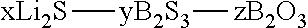

wherein
x is within the range of 55 to 85;
y is within the range of 15 to 45;
z is within the range of 0 to 15; and
x+y+z=100;
(iii) heat-treating the mixture prepared in step (ii) to obtain a melt; and
(iv) quenching the melt obtained in step (iii) to obtain the solid material.

This method is generally referred to as the melt-quench method of the invention. The process is cost-effective and easily scalable. The preferred embodiments of the general formula (I), in particular of a, b, c, d and e described herein in the context of the first aspect of the invention, are equally applicable to the method for preparing a solid material. Similarly, the preferred embodiments of the general formula (II), in particular of x, y and z described herein in the context of the second aspect of the invention, are equally applicable to the melt-quench method of the invention. Additionally the preferred embodiments of the solid materials of the invention (i.e. according to the first or second aspect of the invention) in general (e.g. regarding the identity of X, the conductivities, etc.) are equally applicable to the melt-quench method of the third aspect of the invention.

The provision of both of boron and sulfur in step (i) should be interpreted to mean the provision of elemental boron and elemental sulfur. The elemental boron and elemental sulfur may be provided in in amorphous or crystalline form, wherein the specific allotrope used is not particularly limiting for the invention.

Preparing the mixture of step (ii) may be performed by any suitable means, preferably by mechanical milling (e.g. ball milling).

Step (iii) involves heating the mixture prepared in step (ii) to obtain a melt, i.e. heat-treating at a temperature above the melting temperature of the mixture prepared in step (ii). Step (iii) preferably comprises heat-treating the mixture prepared in step (ii) at a temperature of at least 400° C., preferably at least 600° C., more preferably at least 800° C. The mixture is preferably kept at this temperature for at least 1 hour, preferably at least 2 hours, more preferably at least 4 hours.

Heat-treating may be performed in a closed vessel. The closed vessel may be a sealed quartz tube or any other type of container which his capable of withstanding the temperature of the thermal treatment and is not subject to reaction with the constituents of the glass, such a closed vessel made from a material selected from magnesium oxide, boron nitride, copper, tungsten, silicon nitride, aluminum nitride, carbon and combinations thereof. The heat-treatment of step (iii) may be a single stage or a multiple stage heat-treatment.

It is preferred that step (iii) is performed under an inert gas atmosphere, preferably an inert atmosphere comprising one or more noble gases (such as argon) and/or at a pressure of less than 1 atm, preferably of less than 0.1 atm, more preferably of less than 0.01 atm. Typically and thus preferably, step (iii) is performed at a pressure of less than 10⁻⁴ atm, preferably less than 10⁻⁵ atm and preferably under an inert gas atmosphere, preferably an inert atmosphere comprising one or more noble gases (such as argon). The use of nitrogen as inert atmosphere is generally to be avoided in view of potential reaction with the glass precursors.

It is highly preferred that the melt-quench method of the invention is for the preparation of the solid material according to the first or second aspect of the invention.

In some embodiments of the melt-quench method of the invention step (iv) further comprises the steps of:
(iv)a quenching the melt obtained in step (iii) to obtain solid material;
(iv)b comminuting the solid material of step (iv) a to obtain a particulate solid, such as a powder; and
(iv)c optionally forming a thin film or sheet, preferably a film or sheet having a thickness of less than 500 micron, preferably less than 100 micron by:
   dissolving or suspending the particulate solid of step (iv)b in a liquid phase to obtain a solution or suspension, followed by deposition from the solution or suspension to obtain the thin film or sheet; or
   reheating the particulate solid of step (iv)b to a temperature sufficient to allow drawing a film or sheet, and drawing said film or sheet.

In alternative embodiments step (iv) comprises quenching the melt of step (iii) while maintaining the temperature sufficiently high to allow drawing a thin film or sheet, and drawing said film or sheet, preferably drawing a film or sheet having a thickness of less than 500 micron, preferably less than 100 micron.

It is preferred that the method is operated in the form of a continuous process to produce a continuous glass film or sheet which is cut to a desired size.

The step of quenching in step (iv) is preferably performed by contacting the melt obtained in step (iii) directly, or by contacting the vessel while closed or opened (preferably while closed), with water, ice, an optionally cooled gas (such as air), an optionally cooled metal plate (such as via roller quenching), and/or a chemically inert mold.

In a fourth aspect of the invention, there is provided a solid composition comprising a first solid material which is the solid material as described herein (i.e. the solid material according to the first or second aspect of the invention), and further comprising at least a second solid material having a different composition than the first solid material. The first solid material may be present in the form of discrete particles embedded in a matrix of the second solid material. Alternatively the first solid material and the second solid material may be present in the form of discrete particles which have been blended, optionally in combination with a binder material and one or more further materials, and wherein the blend is preferably compacted. Alternatively the first solid material and the second solid material may be present in the form of different layers of a multilayer thin sheet or film, preferably a multilayer thin sheet or film having a total thickness of less than 500 micron, preferably less than 200 micron. Such solid compositions comprising a first solid material which is the solid material as described herein, and further comprising at least a second solid material having a different composition than the first solid material are particularly useful as cathodes, anodes or separators for an electrochemical cell, in particular as separator or cathode. In some embodiments the second solid material is a cathode material, such as a Nickel-Cobalt or a Nickel-Manganese-Cobalt cathode material.

In a fifth aspect of the invention, there is provided an electrochemical cell comprising the solid material as described herein (i.e. the solid material of the first and second aspect of the invention). In particular, there is provided an electrochemical cell wherein the cathode, anode and/or separator comprises the solid material as defined herein. In some embodiments there is provided an electrochemical cell wherein the cathode, anode and/or separator comprises the solid material as defined herein in the form of a solid composition comprising a first solid material which is the solid material as described herein, and further comprising at least a second solid material having a different composition than the first solid material. Such solid compositions are described in the context of another aspect of the invention. In particularly preferred embodiments of the invention there is provided an electrochemical cell wherein the separator comprises, the solid material as defined herein, optionally in the form of the solid composition as described herein. In some embodiments, the separator consists of the solid material as described herein.

In a sixth aspect of the invention, there is provided the use of the solid material as described herein (i.e. the solid material according to the first or second aspect of the invention), or of the solid composition as described herein (i.e. the solid composition of the fourth aspect of the invention), as a solid electrolyte for an electrochemical cell. Preferably, there is provided the use of the solid material as described herein as a solid electrolyte for an electrochemical cell.

In the context of the various aspects of the invention described herein, suitable electrochemically active cathode materials and suitable electrochemically active anode materials are those known in the art. For example, the anode may comprises graphitic carbon, metallic lithium or a metal alloy comprising lithium as the anode active material. For example, the cathode may comprise a Nickel-Cobalt or a Nickel-Manganese-Cobalt cathode material. Electrochemical cells as described herein are preferably lithium-ion containing cells wherein the charge transport is effected by Li⁺ ions. The electrochemical cell may have a disc-like or a prismatic shape. The electrochemical cells can include a housing that can be from steel or aluminum. A plurality of electrochemical cells may be combined to an all solid-state battery, which has both solid electrodes and solid electrolytes.

A seventh aspect of the present invention concerns batteries, more specifically a lithium ion battery or a lithium metal battery comprising at least one electrochemical cell comprising the solid material as described herein (i.e. the solid material according to the first or second aspect of the invention), for example two or more electrochemical cells as described in the fifth aspect of the invention. Certain embodiments relate to a solid state battery, preferably a lithium solid state battery comprising at least one electrochemical cell comprising the solid material as described herein (i.e. the solid material of the first or second aspect of the invention), for example two or more electrochemical cells as described in the fifth aspect of the invention. Electrochemical cells as described in the fifth aspect of the invention can be combined with one another, for example in series connection or in parallel connection. Series connection is preferred. The electrochemical cells respectively batteries described herein can be used for making or operating cars, computers, personal digital assistants, mobile telephones, watches, camcorders, digital cameras, thermometers, calculators, laptop BIOS, communication equipment or remote car locks, and stationary applications such as energy storage devices for power plants.

A further aspect of the present invention is a method of making or operating cars, computers, personal digital assistants, mobile telephones, watches, camcorders, digital cameras, thermometers, calculators, laptop BIOS, communication equipment, remote car locks, and stationary applications such as energy storage devices for power plants by employing at least one battery or at least one electrochemical cell comprising the solid material as described herein (i.e. the electrochemical cell as described in the fifth aspect of the invention).

A eighth aspect of the present disclosure is the use of the electrochemical cell comprising the solid material of the invention (i.e. the electrochemical cell as described in the fifth aspect of the invention) in motor vehicles, bicycles operated by electric motor, robots, aircraft (for example unmanned aerial vehicles including drones), ships or stationary energy stores. The present invention further provides a device comprising at least one electrochemical cell as described in the fifth aspect of the invention. Preferred are mobile devices such as are vehicles, for example automobiles, bicycles, aircraft, or water vehicles such as boats or ships. Other examples of mobile devices are those which are portable, for example computers, especially laptops, telephones or electrical power tools, for example from the construction sector, especially drills, battery-driven screwdrivers or battery-driven tackers.

The invention is illustrated further by the following examples which are not limiting.

### EXAMPLES

### 1. Preparation of Materials

For each example, 15 g of final material has been produced using the following starting products: amorphous B₂S₃ (99 wt. %), Li₂S (99.9 wt. %), B₂O₃ (99.95 wt. %), LiI (99.95 wt. %) and LiBr (99.9 wt. %) or LiCl (99.9 wt. %). In an argon filled glovebox, appropriate amounts of starting materials were weighed, mixed and introduced in a boron nitride crucible placed in a silica ampoule. The tube was sealed and introduced in a vertical rocking furnace. The melt was homogenized for 5 hours at an internal temperature of 850° C. and then quenched in water at room temperature. The ampoule was then opened in the argon filled glovebox. Glassy material was obtained having orange or brown color with good transparency.

For some examples, an alternative synthesis was performed and successful wherein the amount of Boron and Sulfur brought by B₂S₃ was provided in the form of amorphous elemental B (99 wt. %) and elemental S (99.999 wt. %).

The invention is illustrated further by the following examples which are not limiting.

### 1.1. Preparation of Comparative Example 3 (CEX3)

For each example, 15 g of final material has been produced using the following starting products: amorphous B₂S₃ (99 wt. %), Li₂S (99.9 wt. %) and B₂₀₃ (99.95 wt. %) and X (detailed in the below table). In an argon filled glovebox, appropriate amounts of starting materials were weighed, mixed and introduced in a carbon coated silica ampoule. The tube was sealed and introduced in a vertical rocking furnace. The melt was homogenized for 30 minutes at an internal temperature of 950° C. and then quenched in water at room temperature. The ampoule was then opened in the argon filled glovebox. Glassy material was obtained having yellow, orange or brown color with good transparency.

### 2. Determination of Conductivity

Ionic conductivity was measured by electrochemical impedance spectroscopy (EIS) at room temperature (25° C.) on hot pressed samples in a pellet cell with ion blocking electrodes. The samples were densified at 350 MPa at 125° C. for 5 min. The ionic conductivity was measured under an operational pressure of 125 MPa. For the EIS an excitation voltage of 10 mV was applied in the frequency range of 7 MHz-1 Hz. The data was interpreted by means of an equivalent circuit analysis.

Electronic conductivity was measured at room temperature (25° C.) on hot pressed samples in a pellet cell with ion blocking electrodes. The samples were densified at 350 MPa at 125° C. for 5 min. The electronic conductivity was measured under an operational pressure of 125 MPa. The electronic conductivity was measured via stepwise potentiostatic polarization at 0.2, 0.4 and 0.6 V for 20 min.

Both measurements were conducted with a potentiostat with frequency analyzer (Biologic).

### 3. Determination of Identity of Obtained Glass

Inductively Coupled Plasma Optical Emission Spectroscopy (ICP-OES) was applied to the glassy materials of the examples, prepared as explained above.

A sample of the glassy material is weighed in a glovebox under Ar atmosphere to avoid reaction with water or O₂ and added to a microwave vessel. A combination of acids is added, the vessels are closed and digested in a microwave until clear. The matrix elements (Li & B) are analyzed using a high-precision ICP-OES method.

S is determined via elemental analysis after sample preparation in an Ar-filled glovebox. Sample preparation consists of inserting about 100 mg sample in a sealable capsule, followed by adding the sealed capsule and additives to the ceramic crucible. The filled crucible is subsequently heated in induction furnace under a O₂ atmosphere. The S present is released from the sample, converted into SO₂ gas and detected by a SO₂-specific IR detector. The detected SO₂ signal is finally converted into a S concentration by using a calibration line and taking the exact sample mass into consideration.

The composition of the glasses was found to correspond within the expected margin of experimental error and variation to the overall formula expected based on the molar ratios of the precursors which were submitted to melt-quenching.

### 4. Results

TABLE 1
overall formulas of the synthesized compositions.

| | | | | | | Molar | |
|---|---|---|---|---|---|---|---|
| | Comp. A | | | Comp. | Comp. | Ratio | |
| | Li₂S | B₂S₃ | B₂O₃ | B | C | A:B:C | Overall Formula |
| EX1 | 65 | 30 | 5 | LiI | LiCl | 90:5:5 | Li_{0.36}B_{0.18}S_{0.40}O_{0.04}I_{0.01}Cl_{0.01} |
| EX2 | 65 | 30 | 5 | LiI | LiCl | 80:10:10 | Li_{0.37}B_{0.17}S_{0.37}O_{0.04}I_{0.03}Cl_{0.03} |
| EX3 | 65 | 30 | 5 | LiI | LiCl | 60:20:20 | Li_{0.39}B_{0.14}S_{0.31}O_{0.03}I_{0.07}Cl_{0.07} |
| EX4 | 65 | 30 | 5 | LiI | LiBr | 90:5:5 | Li_{0.36}B_{0.18}S_{0.40}O_{0.04}I_{0.01}Br_{0.01} |
| EX5 | 65 | 30 | 5 | LiI | LiBr | 80:10:10 | Li_{0.37}B_{0.17}S_{0.37}O_{0.04}I_{0.03}Br_{0.03} |
| EX6 | 65 | 30 | 5 | LiI | LiBr | 70:15:15 | Li_{0.38}B_{0.15}S_{0.34}O_{0.03}I_{0.05}Br_{0.05} |
| EX7 | 65 | 30 | 5 | LiI | LiBr | 60:20:20 | Li_{0.39}B_{0.14}S_{0.31}O_{0.03}I_{0.07}Br_{0.07} |
| CEX1 | 65 | 30 | 5 | LiCl | LiBr | 90:5:5 | Li_{0.36}B_{0.18}S_{0.40}O_{0.04}Cl_{0.01}Br_{0.01} |
| CEX2 | 65 | 30 | 5 | LiCl | LiBr | 70:15:15 | Li_{0.38}B_{0.15}S_{0.34}O_{0.03}Cl_{0.05}Br_{0.05} |
| CEX3 | 65 | 30 | 5 | — | — | — | Li_{0.35}B_{0.19}S_{0.42}O_{0.04} |

TABLE 2
ionic and electronic conductivities of EX1-6 and CEX1-2.

| | Ionic Conductivity | Electronic Conductivity |
|---|---|---|
| | (mS/cm) | (mS/cm) |
| EX1 | 0.670 | 9.85 × 10⁻⁶ |
| EX2 | 0.615 | 9.48 × 10⁻⁶ |
| EX3 | 0.705 | 1.08 × 10⁻⁵ |
| EX4 | 0.750 | 1.48 × 10⁻⁵ |
| EX5 | 0.760 | 1.01 × 10⁻⁵ |
| EX6 | 0.540 | 5.64 × 10⁻⁶ |
| EX7 | 0.927 | 7.44 × 10⁻⁶ |
| CEX1 | 0.489 | 9.57 × 10⁻⁶ |
| CEX2 | 0.510 | 7.02 × 10⁻⁶ |
| CEX3 | 0.1 | 5.61 × 10⁻⁵ |

1-10. (canceled)

11. A solid material, which is obtainable by melt-quenching a mixture of A, B and C, wherein the molar ratio of A, B and C in the mixture before quenching is within the range of 40:30:30 to 98:1:1;
wherein component A is according to general formula (II) 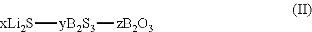
wherein
x is within the range of 55 to 85;
y is within the range of 15 to 45;
z is within the range of 0 to 15;
x+y+z=100; and
wherein component B is LiI;
wherein component C is LiX, wherein X represents Br, Cl or a combinations thereof.

12. The solid material according to claim 11, wherein the solid material has a composition according to general formula (I) 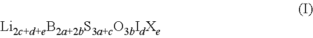
wherein X represents Br or Cl, or combinations thereof;
a is within the range of 0.015 to 0.15;
b is within the range of 0 to 0.04;
c is within the range of 0.07 to 0.25;
d is within the range of 0.001 to 0.24; and
e is within the range of 0.001 to 0.24.

13. The solid material according to claim 11, wherein
x is within the range of 62 to 68;
y is within the range of 27 to 33;
z is within the range of 1 to 8; and
x+y+z=100.

14. The solid material according to claim 11, wherein the molar ratio of A, B and C in the mixture before quenching is within the range of 50:25:25 to 96:2:2.

15. The solid material according to claim 11, wherein the material is a glassy solid.

16. The solid material according to claim 11, wherein the material has an ionic conductivity at 25° C. of at least 0.3 mS/cm.

17. A method for preparing a solid material, a solid material as defined in claim 11, comprising the steps of:
(i) providing the following precursors:
Li₂S;
B₂S₃ and/or both of boron and sulfur;
optionally B₂O₃;
LiI; and
LiX wherein X represents Cl, Br or combinations thereof;
(ii) preparing a mixture comprising the precursors provided in step (i) wherein
in said mixture the molar ratio of the precursors matches the general formula (II) as defined in claim 11 and in said mixture the molar ratio of A, B and C is as defined in claim 11;
(iii) heat-treating the mixture prepared in step (ii) to obtain a melt; and
(iv) quenching the melt obtained in step (iii) to obtain the solid material.

18. An electrochemical cell comprising the solid material as defined in claim 11.

19. The electrochemical cell according to claim 18, comprising a separator, wherein the separator comprises the solid material.

20. Use of the solid material as defined in claim 11 as a solid electrolyte for an electrochemical cell.
